(19) United States
(12) Patent Application Publication
(10) Pub. No.: US 2009/0313121 A1
(43) Pub. Date: Dec. 17, 2009

(54) SYSTEM AND METHOD FOR MARKETING VEHICLES RESIDING ON A DEALERSHIP LOT

(75) Inventors: William Nicholas Post, Mesa, AZ (US); John Wells Morrison, JR., Encinitas, CA (US)

Correspondence Address: MESCHKOW & GRESHAM, P.L.C., 5727 NORTH SEVENTH STREET, SUITE 409, PHOENIX, AZ, 85014, US

(73) Assignee: CDMData Inc., Scottsdale, AZ (US)

(21) Appl. No.: 12/139,390

(22) Filed: Jun. 13, 2008

(51) Int. Cl. G06Q 30/00

(52) U.S. Cl. 705/14.53

(57) ABSTRACT

An electronic system (30) includes several computers (32, 34, 36, 40) in data communication with one another. An electronic window sticker computer (EWS) (32) resides at each vehicle (28) on a dealership lot (22). The EWS computers (32) communicate with the remainder of the system (30) through an RF network (54). A book-in process (78) and/or a lot manager process (146) form a VIN record 96 for a vehicle (28) to which an EWS (32) has been assigned. The VIN record (96) includes a robust set of promotion presentation data (74) that are presented at the EWS (32) using a plurality of screens (112). User inputs are collected at the EWS (32) and routed to the lot manager process (146). Updates to the promotion presentation data (74) may be made frequently, and some updates may be made automatically (204). The updates are reflected at the EWS (32) in real time.

### TECHNICAL FIELD OF THE INVENTION

The present invention relates generally to the marketing of vehicles. More particularly, the present invention relates to systems and methods that are useful in connection with marketing vehicles from dealership lots.

### BACKGROUND OF THE INVENTION

Vehicles, including automobiles, cars, trucks, motorcycles, boats, recreational vehicles, all terrain vehicles, snowmobiles, airplanes, and the like, whether new or used, are typically expensive purchases from the perspective of a potential retail buyer, hereinafter referred to as a customer. The expensive nature of the purchase tends to make the customer highly involved in the sales process and naturally reticent to complete a sales transaction at the beginning of the process. This high level of involvement and reticence often causes the customer to give lengthy and careful consideration to many different factors before actually engaging in a sales transaction for a vehicle. Such factors are referred to herein as collateral information. A non-exhaustive list of examples of collateral information includes price, year, make, model, body, engine, transmission, interior color, exterior color, mileage, fuel efficiency, standard features, aftermarket features, manufacturer's suggested retail price (MSRP), third-party valuations, asking price, financing options, vehicle history reports, vehicle make/model reviews, warranty information, and the like. Moreover, collateral information may also include how such vehicle factors compare to similar factors for other vehicles. In a typical sales transaction, only a portion of the collateral information customers find useful is apparent from physically evaluating the vehicle itself.

In the past, a limited amount of data posted on paper window stickers and given by salespersons has been relied upon to provide customers on a dealership lot with collateral information. But in recent years an abundance of collateral information has become inexpensively available to customers through a number of different sources and is accessible through the Internet. Consequently, an increasing number of customers become quite knowledgeable about the vehicles they eventually purchase and about similar competing vehicles. In many sales transactions, the customer may be better informed than the dealership's salesperson. This unfortunate situation encourages customer reticence by discouraging trust and causing some sales opportunities to be lost.

While a few vehicles may be sold without the customers coming into physical contact with the offered vehicles, these are exceptions. Most vehicle sales transactions occur only after the customer has physically inspected the vehicle and possibly taken it for a test drive. Apparently, a dealership wishing to effectively market vehicles needs to pass at least three hurdles. A customer should be brought into physical proximity with a vehicle on the dealership lot, the customer should have evaluated a robust set of collateral information directed to the vehicle on the dealership lot, and the customer's natural reticence to engage in the expensive purchase should be overcome so that the customer is willing to close a sales transaction.

Efficiently and effectively passing the three hurdles of physical proximity, collateral information consideration, and reticence is fraught with problems. Dealerships have developed many techniques to bring customers to their lots. Such techniques include mass market advertisements, special promotions, sales events, direct mailings, Internet website postings, and the like. But that is only one of the three hurdles.

While resources available through the Internet and car-buying guide books help customers consider collateral information, such resources are often beyond the control of the dealership and not readily available to the customer while at the dealership lot. A dealership receives little benefit from collateral information about vehicles located at a competitor's lot. And, a customer receives little benefit from evaluating collateral information about a hypothetical vehicle or a vehicle located beyond a distance the customer is willing to travel to come into physical contact with the vehicle. A need exists for providing a robust set of collateral information to customers about vehicles actually offered by a dealership, permitting the dealership to exert some level of control over the information, and for providing that collateral information to customers when they are at the dealership's lot.

If a customer visits a dealership lot and fails to find an expected vehicle the customer has researched, then the customer's prior consideration of collateral information may be of little value in connection with the actual on-lot vehicles. With few collateral information resources available on the lot, the on-lot customer may be unable to evaluate a sufficiently robust set of collateral information about actual on-lot vehicles to permit a sales transaction to proceed. And, simply failing to meet customer expectations, whether or not such expectations were justified, tends to encourage customer reticence to engage in a sales transaction. Accordingly, a further need exists to manage customer expectations so that customer reticence is more likely to be overcome by visiting the dealership lot than encouraged. One way this can be accomplished is by providing on-lot collateral information that is reasonably accurate and timely and to keep this collateral information synchronized with other advertisement activities that may be used to bring customers onto the dealership lot in the first place.

But providing a dealership-controllable, robust, and accurate set of collateral information is also fraught with problems. A typical dealership is a busy place with much activity and many vehicles that move from one place to another. While vehicle purchases are expensive from the customer's perspective, vehicle dealerships exist in an intensely competitive business environment where very few individual vehicle sales result in a great deal of revenue for the dealership. Only a limited number of dealership resources are typically dedicated to marketing any single vehicle. And, a wide variety of ever-changing marketing actives are ongoing at a typical dealership. It is difficult for dealerships to provide a robust set of timely, accurate, collateral information for all vehicles being offered for sale.

Paper window stickers have been a traditional way for dealerships to provide on-lot collateral information to on-lot customers. Typically, a paper window sticker is prepared, printed, and glued to a vehicle's window when the vehicle is booked-in for sale at the dealership. Even the traditional paper window sticker has caused accuracy problems when it gets glued to the wrong vehicle. Otherwise, for some types of collateral information, particularly information that tends not to change, the paper window sticker, if applied to the correct vehicle, has nevertheless proven useful to both the dealer and customer. But only a limited amount of information may be presented this way. If one were to follow the conventional paper window sticker teaching and provide a robust set of collateral information of the type that customers seem to need before engaging in a sales transaction, many pieces of paper could be glued to a vehicle window, causing a visibility hazard in connection with conducting test drives.

For other types of collateral information, particularly information that tends to change, the paper window sticker greviously fails to provide much benefit to either the dealership or customer. Vehicle asking price provides an example of such dynamic collateral information, and price is often considered to be a highly influential piece of information for both the dealership and customer. Traditional paper window stickers may display one or perhaps two prices, including an MSRP and/or a dealership asking price. But such prices are notoriously inaccurate, and in particular are likely to be higher than the dealership is willing to accept.

One factor that causes the price posted on a paper window sticker to be too high is that a lower and more accurate price is constantly changing. Vehicle price may change daily as a function of the length of time the vehicle has stood on the lot, as a function of changing rebates and incentives, as a function of features being added to and removed from the vehicle, as a function of changes in the makeup of the entire inventory mix offered by the dealership, and the like. It has been logistically impractical to physically post a constantly changing, but more likely accurate and lower, price for all vehicles on a dealership lot using conventional paper-related techniques of providing collateral information. Dealerships have traditionally posted at-vehicle prices that are higher than they were willing to accept in part because of the difficult logistics involved in determining and tracking ever-changing accurate prices of all vehicles on the dealership lot.

Traditionally, dealerships have often procrastinated serious consideration of the price they would be willing to take until a customer makes a serious offer. While a dealership is somewhat motivated to post a high price in hopes that the customer will make a high offer, this approach encourages customer reticence to engage in sales transactions, causing lost sales opportunities. But the dealership is also motivated to post a low price so that the customer will be enticed to overcome natural reticence and engage in a sales transaction. Accordingly, a need exists for a vehicle marketing system and method for posting at-vehicle prices that can track, in real time, the changing actual prices that a dealership is willing to accept, thereby better balancing the dealership's conflicting motivations to set both high and low prices.

In addition to the logistical problem, a need exists to maintain both consistent and accurate information about a vehicle across the various forums where the information may be presented. Truth-in-advertising regulations necessitate that information presented in advertisements be consistent with the realities encountered on-lot. Otherwise, the dealership may be subjected to “bait and switch” charges. Accordingly, a need exists for a vehicle marketing system and method that allows posting on-lot collateral information that can repeatedly change to track changing situations and track the many and varied marketing activities taking place at the dealership.

For these and other reasons, vehicle dealerships have traditionally used sparse signage on the vehicles they offer for sale and relied more on salespersons to present collateral information and negotiate price once the customer has come to their lot. Ironically, vehicle dealerships have traditionally been quite active in advertising and otherwise promoting their dealerships so as to encourage customers to come onto their lots. This traditional marketing technique foregoes opportunities to more accurately manage the on-lot marketing of vehicles and take greater advantage of sales opportunities.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a schematic map of an exemplary dealership lot;

FIG. 2 shows a block diagram of a computer-network based system configured in accordance with one embodiment of the present invention;

FIG. 3 shows a block diagram of an exemplary electronic window sticker (EWS) computer, which is also depicted in FIG. 2;

FIG. 4 shows a flow chart of an exemplary book-in process performed in accordance with a system and method configured in accordance with one embodiment of the present invention;

FIG. 5 shows a data diagram of exemplary data relationships maintained in a central database portion of a system and method configured in accordance with one embodiment of the present invention;

FIG. 6 shows an exemplary flow chart of a process performed using the EWS computer;

FIG. 7 shows an exemplary arrangement of a plurality of screens through which promotion presentation data are displayed at the EWS computer;

FIG. 8 shows a flow chart of an exemplary process performed using a lot manager (LM) computer, which is also depicted in FIG. 2;

FIG. 9 shows a flow chart of an exemplary central database process performed using data maintained in the central database; and

FIG. 10 shows a flow chart of an exemplary closing process performed in accordance with a system and method configured in accordance with one embodiment of the present invention.

### DETAILED DESCRIPTION OF THE PREFERRED EMBODIMENTS

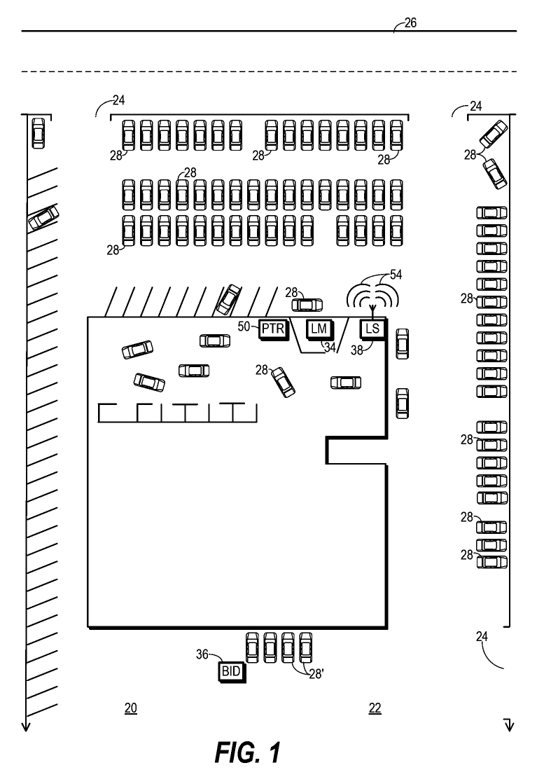

FIG. 1 shows a schematic map 20 of an exemplary dealership lot 22. As shown in map 20, dealership lot 22 has places 24 for ingress and egress with nearby roads 26. Dealership lot 22 also has any number, often many dozens, of vehicles 28 available for purchase by potential buyers. Vehicles 28 may be new vehicles, used vehicles, or a combination of both. For purposes of this description, the type of purchase for which vehicles 28 are offered includes a wide variety of forms of sales transactions, including outright purchase for cash, financing whether or not using dealership-sponsored loans, leasing, renting, and the like. The potential buyers will be referred to as customers below. Vehicles 28 may reside at any location on dealership lot 22, and are likely to move from time to time as they are taken for test drives, repositioned by the dealership for improved marketing effect, cleaned, serviced, have features added or removed, and the like.

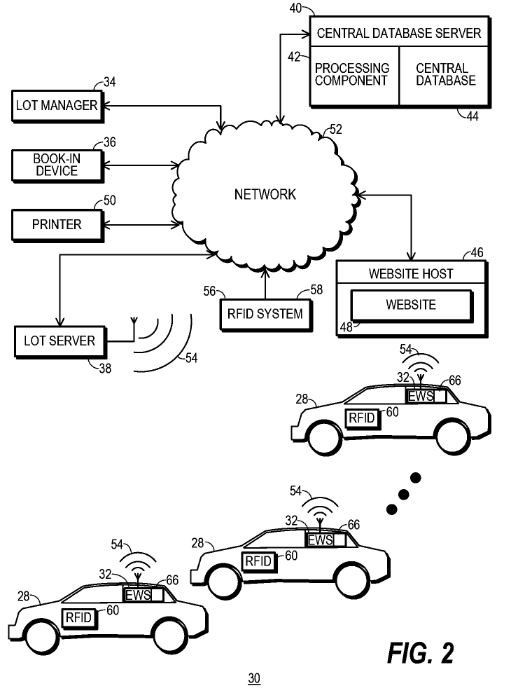

FIG. 2 shows a block diagram of a computer-network based system 30 configured in accordance with one embodiment of the present invention. Referring to FIGS. 1 and 2, system 30 includes a variety of different computers. Electronic window stickers (EWS) 32 are computers that desirably have a one-to-one correspondence with vehicles 28. In other words, each vehicle 28 available for purchase on dealership lot 22 desirably has an electronic window sticker 32 associated with it. A lot manager computer (LM) 34 is located remotely from all electronic window stickers 32, desirably at a location where a managerial level salesperson for the dealership has a desk and desirably where that salesperson has a view of lot 22. Lot manager computer 34 may be provided by a general purpose computer, such as a conventional personal computer, workstation, laptop computer, handheld computer, or the like. A book-in device (BID) 36 is desirably configured as a portable, transportable, or mobile type of computer and used in connection with booking newly arrived vehicles 28′ into inventory. The booking operation includes collecting data about newly arrived vehicles 28′. One suitable form of book-in device 36 is provided by the iTAB™V pen tablet commercially available from CDM Data, Inc., but that particular form of book-in device 36 is not a requirement of the present invention. As a mobile device, book-in device 36 may be used anywhere, but would usually be used where newly-arrived vehicles 28′ are parked, which is usually remote from vehicles 28 that are available for purchase.

A lot server (LS) 38 is a computing device that provides a wireless routing function for dealership lot 22. Lot server 38 is desirably located where it achieves reliable RF coverage of dealership lot 22, and particularly of vehicles 28 that are available for purchase and that have electronic window stickers 32. Although not shown, repeaters may be provided to extend coverage if necessary. While FIG. 1 depicts a single property serving as dealership lot 22, in an alternate embodiment dealership lot 22 may encompass additional remotely located properties, and lot server 38 may be duplicated for each property. Lot server 38 may, but is not required to, provide all the features of a general purpose computer.

A central database server 40 may be located anyplace in the world, including but not limited to, dealership lot 22. Typically, central database server 40 would be remotely located from all electronic window stickers 32. In one embodiment, central database server 40 is owned and operated by an entity other than the dealership, but that is not a requirement. In that embodiment, central database server 40 may serve any number of different dealerships and dealership lots 22. Central database server 40 desirably includes a processing component 42 and a central database portion 44. Processing component 42 executes software which accommodates synchronization and communication among the various computers included in system 30.

Central database 44 stores collateral information about vehicles 28. Central database 44 is considered central because it provides a centralized function for system 30. Collateral information stored in central database 44 may be updated as often as a dealership wishes, and the updates may then flow to the various places and forums which present the collateral information to the public so the collateral information remains synchronized among the various places and forums. This synchronization which flows from the use of a centralized database improves accuracy in the presented collateral information and better manages customer expectations by reducing the likelihood of collateral information describing vehicles that are not among the vehicles 28 available for purchase on dealership lot 22.

A website host 46 may also be located anywhere in the world. Website host 46 is configured in a conventional manner to provide a website 48 that is available to customers through the Internet. In one embodiment, website host 46 is owned and operated by an entity other than the dealership, but that is not a requirement. In that embodiment, website host 46 may serve any number of websites for any number of subscribers, whether or not vehicle dealerships. Desirably, website 48 is configured as desired by the dealership to present collateral information in a manner that promotes sales of vehicles 28.

A printer 50 is located at a common location on dealership lot 22. The common location is associated with all or at least many of vehicles 28 rather than being dedicated to specific vehicles 28. In one embodiment, that common location is inside a dealership building where salespeople have offices. When customers enter requests to print collateral information from electronic window stickers 32, the requests are honored at printer 50. Thus, customers are then required to go to the common location to get the requested printout. This is believed to subtly encourage customers to become more involved and to work toward lessening customer reticence about entering into a sales transaction.

In one embodiment, lot manager 34, book-in device 36, printer 50, lot server 38, central database server 40, and website host 46 are all in data communication with one another through a data network 52. Data network 52 includes any number of routers, modems, cable, optical, wired, or RF data links, and the like, conventionally used in data networks. In one embodiment, data network 52 includes both a local area network (LAN) and the Internet, with central database server 40 and website host 46 being accessed through the Internet and other components being coupled together through a LAN. But all components may also be coupled together through a LAN. Through lot server 38, network 52 is extended into an RF network 54, providing data communication between electronic window stickers 32, central database server 40, lot manager 34, book-in device 36, printer 52, and other components coupled to network 52.

System 30 also uses a radio-frequency identification (RFID) system 56, which includes a central component 58 coupled to network 52 and any number of distributed components 60 located in vehicles 28. A conventional RFID system 56 of the type used by vehicle dealerships may be used in connection with system 30. RFID system 56 determines the locations of vehicles 28 on dealership lot 22, and provides data describing such locations to the components which couple to network 52, such as central database 44 and/or lot manager 34. But the use of RFID system 56 is not a requirement of the present invention. In alternate embodiments, other techniques may be used to determine the locations of vehicles 28.

While FIGS. 1 and 2 depict one embodiment of system 30, other embodiments are also suitable for system 30. For example, one or more of the different computers and functions discussed above may be combined into a single computer. And, dealership lot 22 may take on a wide variety of configurations other than that depicted in FIG. 1, many of which depend upon the particular shape and size of a dealership lot 22 and the geographical location of dealership lot 22.

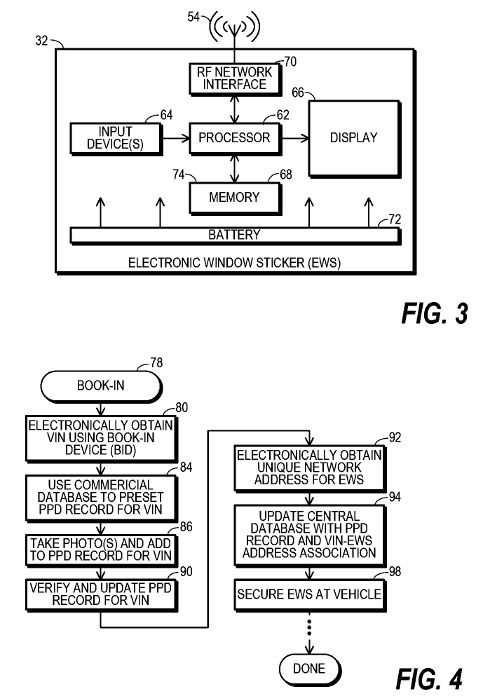

FIG. 3 shows a block diagram of an exemplary electronic window sticker computer 32. Desirably, each of the plurality of electronic window stickers 32 placed at the corresponding plurality of different vehicles 28 available for purchase on dealer lot 22 is configured substantially as depicted in FIG. 3. By using electronic window stickers 32 on vehicles 28, a dealership can more actively manage on-lot marketing efforts of its fleet of vehicles 28. From a single location, such as lot manager computer 34 (FIGS. 1-2), promotional activities directed to either the entire fleet or to single vehicles 28 may be carried out. Thus, a sales force is freed for a more effective deployment. A robust set of collateral information is provided for on-lot customer consideration. The timeliness and accuracy of posted collateral information is improved to help overcome customer reticence. And, promotional activities may be targeted to specific vehicles and specific situations on a real time basis if desired. For the purposes of marketing vehicles 28, real time need not refer to an instantaneous response but instead includes responses often described as being near real time. Responses which occur within a few minutes, and preferably within less than 15 minutes, are deemed to be real time responses for the purposes of the on-lot marketing of vehicles and of this description.

Electronic window sticker 32 is a computer, but it functions in part as paper window stickers have functioned in the past. However, unlike paper window stickers, a vast amount of collateral information targeted to the specific vehicle 28 with which electronic window sticker 32 is associated may be presented, the collateral information, or portions of the collateral information, may be readily changed and updated as often as desired, the collateral information may be updated in real time, and electronic window stickers 32 may be reused by the dealership after vehicles 28 are sold.

Electronic window sticker 32 includes a processor section 62, one or more input devices 64 coupled to processor section 62, a display 66 coupled to processor section 62, a memory section 68 coupled to processor section 62, and a radio-frequency (RF) network interface 70 coupled to processor section 62. Desirably, a battery 72 is provided within electronic window sticker 32 to energize processor 62, input devices 64, display 66, memory section 68, and RF network interface 70.

Electronic window sticker 32 is attached or otherwise located at a vehicle 28 when the vehicle 28 is booked-in at dealership lot 22 (FIG. 1). Desirably, electronic window sticker 32, or at least a portion thereof, is placed inside vehicle 28 for security purposes, but this is not a requirement. Display 66 is positioned to be viewable from outside vehicle 28 (FIG. 2) and intended to be viewed by customers.

Unlike computers configured to be operational in connection with the operation of vehicle 28, electronic window sticker 32 is the opposite. Electronic window sticker 32 is operational when vehicle 28 is turned off, allowing it to present collateral information to customers when parked at dealership lot 22. Battery 72 allows electronic window sticker 32 to operate without an electrical connection to vehicle 28 and without vehicle 28 being turned on. Since electronic window sticker 32 operates without requiring power from vehicle 28, cables are not required and the interference with test drives and errors that would result from unplugging or failing to re-plug cables into vehicle power are avoided. And, electronic window sticker 32 does not contribute to the problem of maintaining battery charge for all vehicles 28 on dealership lot 22. In one embodiment, a solar panel (not shown) is included in electronic window sticker 32 to lessen the chore of maintaining the charge of battery 72.

In one embodiment, processor section 62 is provided by a microprocessor and related components. Input devices 64 may include one or more of a keyboard, keypad, touch-sensitive screen, proximity sensor, pointing device, and the like. A customer or dealership personnel may manipulate input devices 64 to request electronic window sticker 32 to provide a particular type of response. A menu structure is displayed, either electronically or in printed form, and user input presented at input devices 64 causes the menu structure to be followed and different screens of data to be displayed. And, requests may be made through input devices 64, with the requests then being sent to other components of system 30. Printouts may be requested from printer 50 (FIGS. 1-2), or additional information may be requested from central database server 40 (FIG. 2). Display 66 is preferably of a type that is suitable for daylight viewing, such as a liquid crystal display (LCD) or electronic paper display. Memory section 68 includes both memory for storing programs executed by processor section 62 and memory for storing data which are displayed on display 66. Such data displayed on display 66 include collateral information for the vehicle 28 with which an electronic window sticker 32 is associated, referred to as promotion presentation data 74 below. RF network interface 70 permits electronic window sticker 32 to communicate data over RF network 54. RF network interface 70 has a unique network address 76 used by RF network 54 in directing data to and accepting data from electronic window sticker 32. That way, any number of different electronic window stickers 32 may share RF network 54 without interfering with each other. In one embodiment, a conventional media access control (MAC) address may serve as unique network address 76. In one embodiment, a laptop, hand-held or other battery-powered computer may serve as electronic window sticker 32. In another embodiment, a specially-configured battery-powered computer may serve as electronic window sticker 32.

FIG. 4 shows a flow chart of an exemplary book-in process 78 performed in accordance with system 30. Book-in process 78 is desirably performed when a new vehicle 28′ arrives at dealership lot 22 to prepare the new vehicle 28′ so that it may then become a vehicle 28 available for purchase. Among other functions, book-in process 78 assembles promotion presentation data 74 (FIG. 3) for the vehicle 28′ being booked in to dealership lot 22. Book-in process 78 includes a variety of different tasks which may, but are not required to, be organized and sequenced precisely as depicted in FIG. 4.

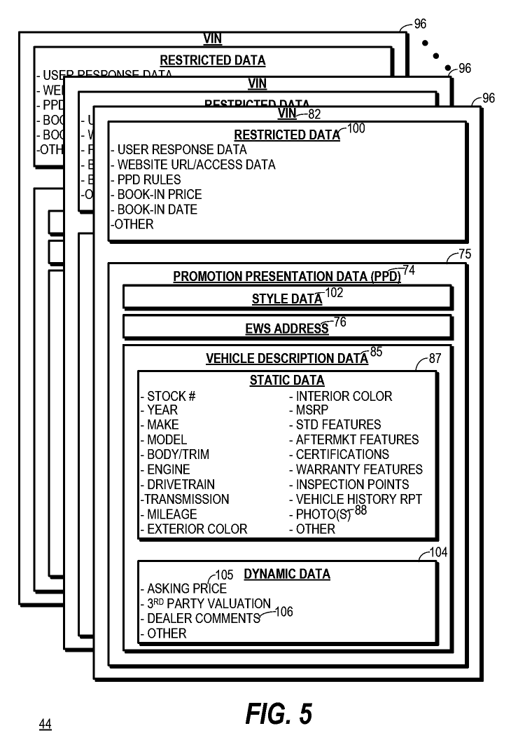

FIG. 5 shows a data diagram of exemplary data relationships maintained in central database 44 (FIG. 2) of system 30. The following discussion refers primarily to FIGS. 4 and 5.

Among the tasks included in book-in process 78 is a task 80 in which a vehicle identification number (VIN) 82 is obtained. Task 80 preferably uses book-in device 36 (FIGS. 1-2) to electronically obtain and copy VIN 82 of new vehicle 28′ into a memory portion of book-in device 36. One embodiment uses a book-in device 36 which includes an optical scanner for this purpose. Optically scanning or other forms of electronically obtaining VIN 82 are advantageous because they reduce opportunities for human error that would inevitably result from manually copying and recording VIN 82.

Following task 80, a task 84 uses a commercially available database to preset a promotion presentation data (PPD) 74 record 75 with data associated in the database with the VIN 82 obtained in task 80. Such commercially available databases are provided by Kelly Blue Book Co., Inc., Chrome Systems, Inc., and/or R.L. Polk & Co. The databases may be included in book-in device 36, or accessible through the Internet. The VIN-accessible data obtainable from such commercial databases typically include: year, make, model, body/trim, engine, drivetrain, transmission, exterior color, interior color, MSRP, and standard dealer-installed features. For a given vehicle 28, these data items describe the specific vehicle 28′ whose VIN 82 has been used to access the commercially available database, and are collectively referred to as vehicle description data 85 herein. Moreover, these data items tend not to change while the vehicle 28 is on dealership lot 22, although that is not a requirement of the present invention. Accordingly, such data collected in task 84 are, for the most part, referred to as static data 87.

Following task 84, a task 86 is performed to cause one or more photographs 88 to be taken of vehicle 28′ and added to the promotion presentation data (PPD) record 75 being assembled. In one embodiment, book-in device 36 includes a digital camera for this purpose, but that is not a requirement of process 78. Desirably, the types of photographs 88 taken at task 86 are the sort of photographs that will be useful in promoting the sale of vehicle 28′ and are the sort of photographs typically posed on websites and in printed publications where vehicles are advertised. Not only may photographs 88 by used by website 48 (FIG. 2), but one or more photographs 88 are desirably displayable at electronic window sticker 32. Even though electronic window sticker 32 will be physically located at the very vehicle 28 whose photograph is depicted, a photograph is useful is maintaining accuracy. Through displaying photograph 88, dealership personnel can easily verify that electronic window sticker 32 gets associated with the correct vehicle 28 both for initial installation and if removed in furtherance of marketing activities, thereby reducing the likelihood of electronic window sticker 32 being attached to the wrong vehicle 28.

Next, a task 90 verifies and updates the promotion presentation data (PPD) record 75 for the VIN 82 of the subject vehicle 28′. The dealership personnel managing book-in process 78 desirably reviews the data currently populating the promotion presentation data record 75 and the subject vehicle 28′ to determine whether the recorded data appear accurate. And, the vehicle 28′ is inspected to determine whether additional vehicle description data 85 may be recorded. For example, mileage may be added or updated, and the presence of after market features or the removal of standard dealer-installed features may be noted. The promotion presentation data record 75 is altered to make any needed changes or additions.

Following task 90, a task 92 obtains unique network address 76 for an electronic window sticker (EWS) 32 that is currently not associated with any vehicle 28. This electronic window sticker 32 may be a new one or may be one that had previously been used in association with a vehicle that has since been purchased and removed from dealership lot 22. Desirably, task 92 electronically obtains and copies the unique network address 76 to reduce human error. In one embodiment, a key-press or sequence of key-presses at input device 64 (FIG. 3) of electronic window sticker 32 causes the electronic window sticker's unique network address 76 to be displayed at display 66, where it may then be scanned by book-in device 36. In another embodiment, a key-press or sequence of key-presses at input device 64 causes the address 76 to be communicated upstream away from electronic window sticker 32 toward central database 44, book-in device 36, and/or lot manager computer 34 where it may then be associated with the promotion presentation data record 75 being assembled and VIN 82 obtained above in task 80.

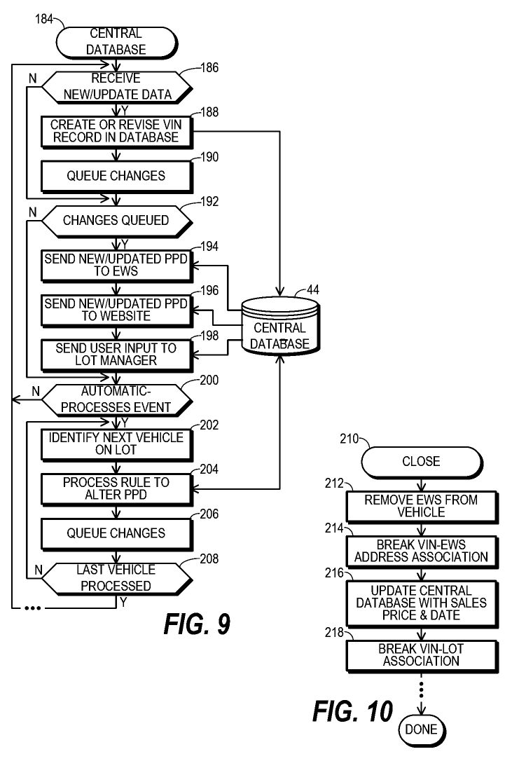

Next, a task 94 updates central database 44 with the promotion presentation data 74 thus far assembled and with the VIN 82 to address 76 association established through the operation of task 92. A VIN record 96 is formed in database 44. As depicted in FIG. 5, any number of VIN records 96 may be included in database 44 for any number of corresponding VINs 82. Thus, tasks 92 and 94 are included in a chain of events wherein electronic window sticker 32 causes its unique network address 76 to be electronically copied to central database 44, wherein it is included in a VIN record 96 for the VIN 82 of the vehicle 28′ where the electronic window sticker 32 will be placed. As will be discussed below in connection with FIG. 9, the promotion presentation data 74 will then be queued for immediate download into the specified electronic window sticker 32 whose address 76 is included in the promotion presentation data record 75 included as a subset of VIN record 96.

After task 94, a task 98 causes the subject electronic window sticker 32 to be secured at the subject vehicle 28′ in the above-discussed manner where display 66 is viewable from outside vehicle 28′. Book-in process 78 eventually ends at some point following task 98. As indicated by ellipsis in FIG. 4, any number of other tasks may also be included in book-in process 78, but such tasks are omitted here for the sake of clarity. But at some point vehicle 28′ is made available for purchase on dealership lot 22, and at this point process 78 ends with respect to that vehicle 28. At this point, promotion presentation data 74 have been formed for the vehicle 28, and the promotion presentation data 74 are configured to foster or otherwise encourage a sale of that specific vehicle 28.

VIN record 96 in database 44 is desirably configured to include additional data than may have been collected in process 78. As depicted in FIG. 5, VIN record 96 may include a subset restricted data record 100. Restricted data record 100 includes data items that, unlike promotion presentation data record 75, are not intended for publication. Restricted data record 100 may include such data items as: user response analytics or other statistics collected by electronic window sticker 32 while associated with its vehicle 28 and usable in data mining activities; a website URL and access credentials associated with the website 48 (FIG. 2) where the subject vehicle 28 is being advertised; rules or programming instructions to be followed in automatically processing the promotion presentation data (PPD) 74; the book-in price or cost to the dealership of the subject vehicle 28; the book-in date; and/or other items that may be useful to the dealership.

FIG. 5 also shows that style data 102 are desirably included in the promotion presentation data record 75 for the subject vehicle 28. Style data 102 define graphics, logos, trademarks, borders, text fonts, highlighting, text formatting such as bold and italics, background or watermarks, along with placement, colors and intensities to associate with such items. Style data 102 do not specifically describe the subject vehicle 28. Thus, style data 102 are different from vehicle description data 85. A primary goal for vehicle description data 85 is that the subject vehicle 28 be accurately described in detail. But the subject vehicle itself is not as great an issue for style data 102. The dealership has great freedom and flexibility in changing style data. Typically, style data 102 is changed, manipulated, or created as desired to maximize its marketing influence. As a non-exhaustive list of examples, a dealership may configure style data 102 to be male or female oriented, to be single or family oriented, young or old oriented, or to convey a patriotic, holiday, pastoral, or sales event theme. And, style data may be used to emphasize some items of vehicle description data 85 while deemphasizing others. Those skilled in the art of marketing vehicles can design different style data as deemed appropriate for the specific situation. And, different sets of style data 102 may be individually assigned to specific vehicles 28 in real time, or style data 102 may be set the same for all of vehicles 28 at once. Style data 102 may be initially assigned a default or preset setting, which can then be changed as desired.

FIG. 5 also shows that dynamic data 104 are desirably included in the promotion presentation data record 75 for the subject vehicle 28. Dynamic data 104 are included as a subset of vehicle description data 85. Dynamic data 104 are considered dynamic in comparison to static data 87, and vice-versa. But nothing requires any item of static data 87 to remain frozen or any item of dynamic data 104 to change. But generally, dynamic data 104 do change while vehicle 28 is on dealership lot 22. And, dynamic data 104 may change often. Dynamic data includes such items as an asking price 105 for the subject vehicle 28. Asking price 105 may change daily, or even more often, as a function of the length of time the vehicle has stood on the lot, as a function of changing rebates and incentives, as a function of features being added to and removed from the vehicle, as a function of changes in the makeup of the entire inventory mix offered by the dealership, and the like. Third party valuation data, such as that provided by Kelly Blue Book Co., Inc, and others, are also in constant flux, as are other items of dynamic data. In addition, dealer comments 106 are likely to change. Dealer comments may be tailored to fit the situation, as that situation changes from hour to hour. Dealer comments may include any sort of information that the dealership wishes to convey to an on-lot customer. A non-exhaustive list of examples includes slogans such as “Great Value”, “Great Family Car,” “Ask About Our Special Deal”, “One-Owner”, “Check Out The Low Mileage On This One,” “Priced Under The Kelly Blue Book Value”, and the like. Dealer comments 106 are believed to be particularly advantageous in helping overcome customer reticence by providing a capability to further emphasize characteristics of the subject vehicle 28 or the situation.

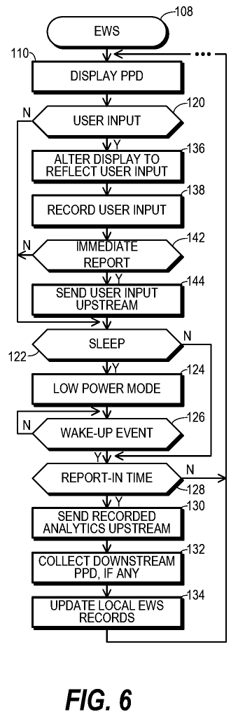

FIG. 6 shows an exemplary flow chart of a process 108 performed using an electronic window sticker (EWS) 32. Desirably, process 108, or an equivalent, is independently and simultaneously performed at each electronic window sticker 32. Moreover, process 108 is desirably performed continuously while the vehicle 28 to which the electronic window sticker 32 has been assigned is on dealership lot 22. Computer software stored in memory 68 (FIG. 3) and executed by processor section 62 (FIG. 3) plays an influential role in the performance of process 108. Process 108 includes a variety of different tasks which may, but are not required to, be organized and sequenced precisely as depicted in FIG. 6. Process 108 is desirably operational while the vehicle 28 to which electronic window sticker 32 is attached is turned off.

Process 108 includes a task 110 which displays promotion presentation data 74 (FIG. 5) at display 66 (FIG. 3). As is discussed in more detail below, promotion presentation data 74 for the subject vehicle 28 has been downloaded to electronic window sticker 32.

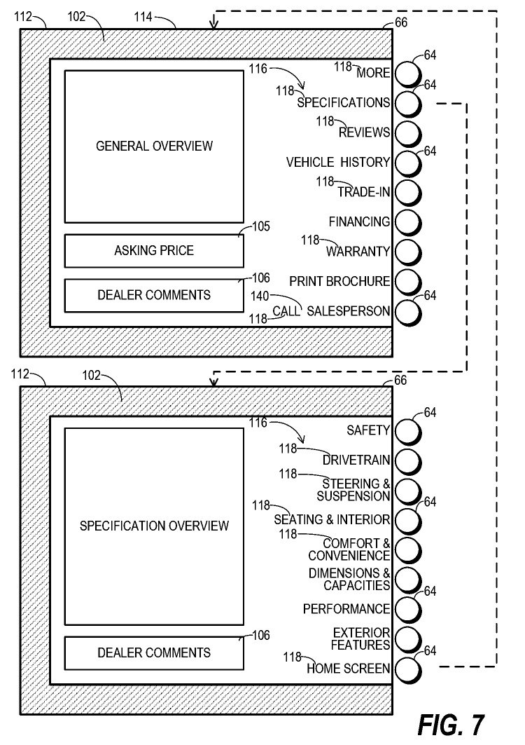

FIG. 7 shows an exemplary arrangement of a plurality of screens 112 through which promotion presentation data 74 are displayed at electronic window sticker 32. In particular, FIG. 7 shows only two screens 112 but many additional screens 112 are desirably displayable. Referring to FIGS. 6 and 7, a screen 112 represents the set of data that is presented in display 66 at one time. Promotion presentation data 74 includes too much data to be presented in one screen 112. Thus, a screen 112 is a subset of promotion presentation data 74 that is displayed together. In one embodiment, promotion presentation data 74 may be partitioned into screens 112 as desired by the dealership. Nothing requires promotion presentation data 74 to be partitioned as depicted for convenience in FIG. 7.

The partitioning of promotion presentation data 74 depicted in FIG. 7 includes an overview or home screen 114 that is preferably at the top of a screen hierarchy. Desirably, home screen 114 is displayed as a customer approaches vehicle 28 for the first time. Home screen 114 may be queued for display whenever no user input has been detected at electronic window sticker 32 for a predetermined period of time. Overview screen 114 may present high level data items, such as year, make, model, engine, transmission, and the like. In addition, overview screen 114 may present data items that a dealership wishes to use for grabbing a customer's attention, such as a particular set of style data 102, simply shown as a border in FIG. 7, dealer comments 106, and an asking price 105.

FIG. 7 also depicts a menu structure 116 in connection with screens 112. In one embodiment, menu selections 118 are electronically displayed in display 66 and associated with input devices 64 to indicate which input device 64 a user should manipulate to cause the screen 112 to change in accordance with the indicated menu selection 118. In another embodiment, menu selections 118 may be physically printed. In another embodiment, a user may manipulate one or more user input devices 64 which serve as a scroll buttons (not shown) to cause the display to scroll to new screens 112.

Following task 110, a query task 120 determines whether a user input has occurred. When no user input is detected at task 120, a query task 122 is performed to determine whether conditions warrant causing electronic window sticker 32 to enter a sleep mode in which it will consume less power. One such condition may be the detection of inactivity at user input devices 64 for a predetermined period of time, but other conditions may be evaluated as well. If task 122 determines that a sleep mode is warranted, a task 124 causes electronic window sticker 32 to enter its sleep mode, and a query task 126 determines whether a wake-up event has occurred. A wake-up event may be defined as the passage of a predetermined period of time in the sleep mode, the activation of a proximity sensor, the activation of a button or other user input device 64, and/or the like. So long as no wake-up event has occurred, process 108 remains at task 126.

When a wake-up event is detected at query task 126 or when task 122 determines that electronic window sticker 32 should not enter its sleep mode, a query task 128 is performed. Task 128 determines whether electronic window sticker 32 should report in to system 30. At task 128, process 108 may evaluate the current time in connection with a schedule. The schedule may, for example, establish report-in times every 10 minutes if desired. Or, report-in times may be programmed to occur at a predetermined duration after a previous report-in event. In one embodiment, report times occur more frequently (e.g., every few seconds) when user input has been detected in the recent past (e.g., the last minute), then less frequently (e.g., every 30 minutes) when no user input has been recently detected.

When task 128 determines that the report-in time has occurred, a task 130 is performed to send any recorded analytics upstream toward central database 44. The analytics may include a record of keystrokes and corresponding timestamps which can be used to determine which information customers appear to be most interested in and how much time they spent considering such information. The analytics are desirably routed through RF network interface 70 (FIG. 3), over RF network 54, and eventually arrive at central database 44. The evaluation of such analytics by the dealership provides feedback that can be used to improve future marketing efforts.

Following task 130, a task 132 collects any promotion presentation data (PPD) 74 that has been directed toward electronic window sticker 32. In one embodiment, such data may be held at lot server 38 (FIGS. 1-2) until the addressed electronic window sticker 32 reports in, then downloaded. Thus, when a newly arrived vehicle 28′ is booked-in in accordance with process 78 (FIG. 4), the promotion presentation data 74 assembled using process 78 is downloaded to the electronic window sticker 32 in real time and available for display. Or, a portion of the promotion presentation data 74, such as asking price 105, may be revised at any time, and queued for delivery to the electronic window sticker 32 as soon as the electronic window sticker 32 reports in.

In one scenario, a lot manager may learn that a particular customer is viewing a vehicle 28 and make an immediate response, such as modifying style data 102 or modifying dealer comments 106 for the vehicle. These updates may then be downloaded in real time through RF network interface 70 (FIG. 3) to the vehicle's electronic window sticker 32 through the operation of task 132. This real time modification capability permits the active on-lot marketing of vehicles 28 without having a salesperson accost the customer. As a result, it is believed that customer reticence can be subtly diminished and the customer's attitude more effectively shifted toward being ready to talk to a salesperson.

After task 132, a task 134 updates the local electronic window sticker records in its memory 68 (FIG. 3), and program control loops back toward task 110 to display the updated records. As indicated by ellipsis in FIG. 6, process 108 may include any number of other tasks whose descriptions are omitted for clarity.

As discussed above, query task 120 determines when an input has been provided at input devices 64. When an input is detected, a task 136 alters display 66 in accordance with the user input. FIG. 7 depicts a scenario where a button adjacent to a “specification” menu selection 118 may be pressed, causing a second-level screen 112 to be displayed at task 136. The second-level screen for this example may display a specification overview and menu selections 118 may include safety, drivetrain, steering and suspension, seating and interior, comfort and convenience, dimensions and capacities, performance, and exterior features. Another menu selection 118 may be provided to move back to the home screen 114. FIG. 7 also depicts a “more” menu selection 118 in home screen 114. Through this “more” selection, a second-level screen 112 (not shown) having any number of additional options is displayed. One of these additional options is desirably a menu selection 118 for a third-level utility screen. Through the utility screen, the user may cause display 66 to show a photograph 88 or the unique network address 76 of the electronic window sticker's RF network interface 70, or other items as may be deemed appropriate. Other menu selections 118 should cause other context-appropriate screens 112 to display during task 136.

FIG. 7 depicts a scenario where one of the menu selections 118 is a “call salesperson” button. Essentially, a customer should press this button if the customer wishes to talk to a salesperson. The call salesperson button is one form of an interest-in-vehicle indicator 140. But other forms of interest-in-vehicle indicator 140 may be devised as well. For example, process 108 may automatically activate interest-in-vehicle indicator 140 when any key press in detected, when a proximity sensor detects a customer presence near vehicle 28, or when a predetermined number of key presses or duration of customer activity at the vehicle 28 is detected. FIG. 7 also depicts a “print brochure” menu selection 118. A customer should press this button if the customer wishes to have a brochure for the vehicle 28 printed at printer 50 (FIGS. 1-2). If either of these menu selections is pressed, process 118 should respond with a second-level screen 112 at task 136 that further instructs the customer as is appropriate for the context. For example, the second-level screen 112 may instruct the customer to wait at the vehicle for a salesperson or to pick up the brochure at a particular station in the dealership's building.

Following task 136, a task 138 collects or records a date stamp and the particular form of user input that was detected above in task 120 to include in the set analytics that will be uploaded as discussed above in connection with task 130.

After task 138, a query task 142 determines whether the type of input collected and recorded above in task 138 was the type that should trigger an immediate report upstream toward central database 44. Interest-in-vehicle indicator 140 is one form of user input that triggers an immediate upstream report. The print brochure button is another form of user input that triggers an immediate upstream report. Other such user inputs may include situations where the customer might expect immediate feedback. For example, a second- or third-level screen 112 may be configured for a customer to identify the customer's trade-in. Task 142 may determine that such data should be immediately sent upstream so that a typical trade-in value may be calculated at central database server 40 and returned in real time. If task 142 determines that an immediate report should be sent upstream, then a task 144 is performed to send the recently collected user input upstream through RF network interface 70 in real time. Task 142 operates substantially the same as task 130 above. If a real time response is expected to the report sent upstream, task 144 may also alter the report-in time parameters evaluated in task 128, discussed above, so that the downstream response will be collected by task 132 nearly as soon as it becomes available.

Following task 144 and when task 142 fails to detect user input necessitating an immediate upstream report, program flow for process 108 proceeds to task 122, discussed above.

Accordingly, process 108 operates continuously to collect promotion presentation data 74 directed downstream, to display screens 112 and menu structure 116 at display 66, to collect input obtained from input devices 64, to route such input upstream, and to accommodate the routing of upstream and downstream data in real time where desirable.

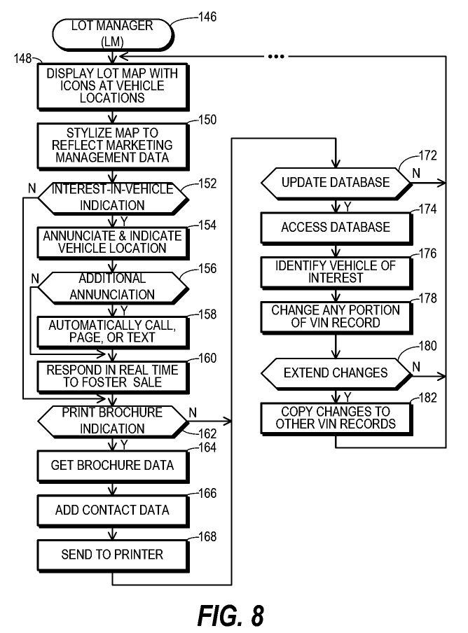

FIG. 8 shows a flow chart of an exemplary process 146 performed using lot manager computer 34 (FIGS. 1-2). In one embodiment, lot manager computer 34 is provided by a general purpose computer that has data connectivity to central database server 40. Computer software stored in this general purpose computer plays an influential role in the performance of process 146. Process 146 includes a variety of different tasks which may, but are not required to, be organized and sequenced precisely as depicted in FIG. 8.

Process 146 includes a task 148 in which map 20 (FIG. 1) of dealership lot 22 is displayed at lot manager computer 34. Desirably, suitable icons are displayed at locations on map 20 where vehicles 28 currently reside, thereby indicating locations of vehicles 28 on dealership lot 22. The locations of vehicles 28 may be determined from RFID system 56 in a conventional manner.

Next, a task 150 stylizes map 20 to reflect marketing management data. Task 150 may display data in connection with the vehicle 28 icons that inform a lot manager of pertinent facts about the vehicle 28. In one embodiment, the colors of the icons may be configured to indicate the length of time the vehicle 28 has been on dealership lot 22.

After task 150, a query task 152 determines whether an interest-in-vehicle indicator 140 (FIG. 7) has been received. In one embodiment, process 146 is logged onto and has access to central database server 40 by providing proper credentials. In this embodiment, as soon as the interest-in-vehicle indicator 140 has been routed upstream to central database 44 and included therein with user response data, task 152 is answered in the affirmative. In another embodiment, the report which conveys the interest-in-vehicle indicator 140 is routed directly to lot manager computer 34 where it is detected at task 152 in process 146.

When task 152 detects that interest-in-vehicle indicator 140 has been received, a task 154 is performed to annunciate indicator 140 and to indicate the location of the vehicle 28 from which it was sent. Task 154 may, for example, cause the vehicle icon that corresponds to the subject vehicle 28 to flash, thereby indicating both the receipt of interest-in-vehicle indicator 140 and the location of the subject vehicle 28. In addition, task 154 may cause lot manager computer 34 to emit a beeping sound, thereby indicating the receipt of interest-in-vehicle indicator 140. But other forms of annunciation may be utilized as well.

The lot manager is typically responsible for marketing all vehicles 28 on dealership lot 22. But the lot manager is not usually out among vehicles 28 and cannot be aware of all activities occurring everywhere on dealership lot 22 at each instant. As a result of task 154, a lot manager's attention is specifically directed to a vehicle 28 that has attracted some customer interest even though the lot manager may be remotely located from the subject vehicle 28 within dealership lot 22 at that instant.

After task 154, a query task 156 determines whether additional forms of annunciation are required. Since the lot manager may not always be at lot manager computer 34, or not always logged onto central database server 40, other forms of annunciation may be desirable. When, for these and other reasons, other forms of annunciation are required, a task 158 is performed. Task 158 automatically calls, pages, or texts to deliver the interest-in-vehicle indicator 140. Thus the lot manager, or other dealership personnel, may receive an automatically placed telephonic call, a pager message, and/or text message to indicate customer interest in a vehicle 28. Again, the indication of customer interest in a specific vehicle 28 is annunciated at a location remote from the subject vehicle 28.

After task 158, or when query task 156 determines that no additional annunciation is required, a task 160 is performed to respond to the interest-in-vehicle indicator 140 in real time and in a manner that fosters a sale of the subject vehicle 28. During task 160 a wide variety of responses may occur to encourage, promote, develop, or otherwise advance the sale of the vehicle 28. For example, the lot manager may direct a salesperson to go out to the vehicle 28.

But other real time responses, some of which are more subtle and sophisticated, are also possible, with or without directing a salesperson to go out to the vehicle 28. For example, promotion presentation data 74 for the subject vehicle 28 may be changed in a meaningful way. In one scenario, the lot manager may observe that a female (or male or elderly) customer was the cause of the interest-in-vehicle indicator 140 and change the vehicle's promotion presentation data 74, and particularly style data 102 and/or dealer comment data 106, to a style and comment believed to be particularly influential to a female (or male or elderly) customer. Or, in another scenario, the lot manager may notice that a young adult and parent are inspecting a vehicle 28, then cause style data 102 and/or dealer comments 106 to emphasize performance data when the young adult is interacting with the electronic window sticker 32 but emphasize safety data when the parent is interacting with the electronic window sticker 32. A wide variety of such responses are enabled through the operation of system 30.

The response of task 160 enabled by system 30 allows an efficient use of the dealership's sales force. On busy days when a salesperson may not be available, responses may nevertheless be made through electronic window stickers 32. Or, when the situation indicates that a salesperson response may be too forward, subtle responses may be easily and quickly made through electronic window stickers 32. It is believed that this quick and subtle form of response is helpful in overcoming customer reticence.

After task 160, or when task 152 determines that no interest-in-vehicle indicator 140 has been detected, a query task 162 determines whether a print brochure request has been received in connection with any particular vehicle 28. If so, a task 164 is performed to obtain brochure data from central database 44, and a task 166 is performed to add contact data, such as the name and contact information of a salesperson, to that brochure data. Process 146 may tailor tasks 164 and 166 to specific print requests. For example, nothing requires an entire comprehensive brochure to be produced, but the print brochure request and tasks 164-166 may be directed to only a portion of the promotion presentation data 74 that may be available for printing. Task 166 may also add other information deemed appropriate to the circumstances, such as an indication that the prices are valid only until a specified date and time. Next, a task 168 sends the brochure data to printer 50 to make a paper copy. In addition, tasks 164-168 may annunciate the brochure request so that a salesperson may optionally be directed to the printer to greet the customer and perhaps offer other services, such as a test drive or allowing the customer to email the brochure to an email address the customer may wish to specify.

Following task 168 or when task 162 fails to detect a print brochure request, a query task 170 determines whether a desire exists to update some portion of central database 44. That desire may, in one embodiment, be indicated by an appropriate input from the user of lot manager computer 34. While lot manager computer 34 may be used primarily in a capacity of updating database 44, in one embodiment lot manager 34 may also be used to book-in a new vehicle 28′ using this updating procedure. When a desire to update is detected, a task 172 is performed to access database 44, if necessary, by providing the appropriate credentials so that central database server 40 will allow data to be entered. Task 174 may utilize a browser and cause that browser to navigate the Internet to access database 44. Next, a task 176 identifies the subject vehicle 28 or 28′ of interest to database 44. Task 176 may, for example present the vehicle's VIN 82 or stock number. Then, a task 178 is performed to change any portion of the indicated VIN record 96.

A common use for task 178 would be to revise asking price 105, change dealer comments 106, or change style data 102. But an entire book-in process may be performed during task 178 if desired. Or, if any portion of description data 85 has been found to be inaccurate, such data may be corrected during task 178. Alternatively, task 178 may be used to establish rules that will be followed to automatically process promotion presentation data 74 for the specified vehicle 28. Accordingly, through task 178 lot manager computer 34 may be used to form the promotion presentation data 74 that gets displayed at electronic window stickers 32.

After task 178, a query task 180 determines whether to extend the changes just entered in task 178 to other vehicles 28, or perhaps all vehicles 28 on dealership lot 22. If task 178 determines that the changes are to be extended, then a task 182 is performed to copy specified changes to VIN records 96 (FIG. 5) of specified vehicles 28. Tasks 180 and 182 may be used, for example, to quickly and easily make a blanket change to style data 102 or dealer comment data 106 for all vehicles 28 on dealership lot 22. As a result, central database server 40 will substantially concurrently route updated promotion presentation data 74 to a plurality of vehicles 28. Following task 182 or when task 180 detects no desire to extend changes to a plurality of vehicles 28, program flow for process 146 proceeds back to task 148, discussed above. As indicated by ellipsis in FIG. 8, process 146 may include any number of other tasks or sub-processes that are omitted here for the sake of clarity.

FIG. 9 shows a flow chart of an exemplary central database process 184 performed using VIN records 96 maintained in the central database 44. Process 184 may be performed using processing component 42 (FIG. 2) and central database 44 of central database server 40 (FIG. 2). Computer software stored at server 40 plays an influential role in the performance of process 184. Process 184 includes a variety of different tasks which may, but are not required to, be organized and sequenced precisely as depicted in FIG. 9.

Process 184 includes a task 186 which determines whether new or update data have been received for storage in database 44. New or update data may be received as a result of the performance of tasks 94 (FIG. 4), 130 and 144 (FIG. 6), or 178 and 182 (FIG. 8), all discussed above. If such new or update data are received, a task 188 is performed to create or revise the relevant promotion presentation data record 75 with the database 44. In one embodiment, such new or update data should be accompanied by the VIN 82 of the vehicle 28 to which the data applies, but other keying data, such as stock number, may be used as well. Next, a task 190 queues the changes for downstream, real-time communication away from central database 44.

Following task 190, or when task 186 fails to detect the presence of any new or update data, a query task 192 determines whether any changes in a vehicle's promotion presentation data record 75 have been queued for real-time delivery downstream. If such changes are queued, a task 194 sends such changes in the vehicle's promotion presentation data 74 to the electronic window sticker 32 whose unique network address 76 is associated with the vehicle's VIN 82 in the VIN record 96. Thus, task 194 causes promotion presentation data 74 to flow to the appropriate electronic window sticker 32, where it is displayed as discussed above in connection with FIG. 6. Next, a task 196 sends the queued new or update data to website 48 (FIG. 2). Through the operation of tasks 194 and 196, those portions of promotion presentation data 74 which are common to both the on-lot electronic window stickers 32 and website 48 are synchronized. The synchronization improves accuracy in the promotion data presented in the various forums and places where marketing activities take place and is believed to be helpful in reducing customer reticence.

After tasks 194 and 196, a task 198 sends user input recently received from electronic window stickers 32 to lot manager computer 34. In one embodiment, all such user input is sent to lot manager computer 34. In another embodiment, only the user input which requested a real-time response, such as a print brochure request or an interest-in-vehicle indicator 140, is sent.

Following task 198 or when task 192 fails to detect any changes queued for downstream communication, a query task 200 determines whether an event has occurred which triggers the performance of an automatic process. An automatic process is automatic from the perspective of the dealership and triggered in response to events other than manual input from the dealership. Such an event may occur in response to the passage of time, such as once a day, in response to the receipt of certain types of data, such as new vehicle rebate information from a vehicle manufacturer, or the like. If such an event has occurred, then process 184 operates in a programming loop to process rules for all vehicles on dealership lot 22. In particular, a task 202 identifies a VIN record 96 for a next vehicle 28 from dealership lot 22. Then, a task 204 processes a rule or rules to alter promotion presentation data record 75 in accordance with the rule. Rules may be specified for a vehicle 28, perhaps through the performance of task 178 (FIG. 8) and stored with restricted data 100 in the vehicle's VIN record 96. Task 204 may, for example, automatically revise asking price 105. For automatically revising asking price 105, a rule may specify that price is to be discounted a certain amount for each day a vehicle 28 remains on dealership lot 22 without being sold. The rule may specify different amounts depending upon the current asking price 105. Or the receipt of new rebate data may trigger a rule that offsets asking price 105 for the affected vehicles 28 by the amount of the rebate, assuming that disclaimers are included stating that the purchaser is to assign any rebate to the dealership. In another scenario, style data 102 and/or dealer comment data 106 may be automatically updated upon the occurrence of some event, such as a particular day of the week or time of day.

After processing all pertinent rules for the specified vehicle 28, a task 206 is performed to queue any changes for downstream delivery for any promotion presentation data 74 that has changed as a result of the rule processing of task 204. Then a query task 208 is performed to determine whether the last vehicle 28 on dealership lot 22 has been evaluated for automatic rule processing. So long as additional vehicles 28 remain to be processed, program flow proceeds back to task 202. As a result of tasks 202-208, any promotion presentation data 74 updated for the fleet of vehicles 28 on dealership lot 22 gets substantially concurrently routed to the corresponding vehicles 28. When the last vehicle 28 has been processed, task 208 directs program flow back to task 186. But, FIG. 9 shows ellipsis to indicate that any number of additional tasks may also be performed within process 184, but that such tasks are omitted here for clarity.

FIG. 10 shows a flow chart of an exemplary closing process 210 performed in accordance with system 30 and its methodology. Closing process 210 is performed when a vehicle 28 is sold. Process 210 may be performed, at least in part, using lot manager computer 34 and may be performed in conjunction with task 178 of process 146 (FIG. 8). Process 210 includes a variety of different tasks which may, but are not required to, be organized and sequenced precisely as depicted in FIG. 10.

Process 210 includes a task 212 in which the electronic window sticker 32 is removed from the recently sold vehicle 28. Next, a task 214 is performed to break the association between the VIN 82 of the recently sold vehicle 28 and the unique network address 76 of that vehicle's electronic window sticker 32 so that the electronic window sticker may then be reused on another newly obtained vehicle 28′. A task 216 then updates central database 44 with the actual sales price date for the purchase transaction. Task 216 allows data mining operations to take place that can lead to improved marketing activities in the future. After task 216, a task 218 breaks the association with the VIN and the dealership in central database 44. However, the VIN record 96 may be maintained within database 44 in case the recently sold vehicle 28 shows up for sale at some future date, whether at this or another dealership lot 22. Close process 210 is complete at some point following task 218.

In summary, at least one embodiment of the present invention provides an improved system and method for marketing vehicles residing on a dealership lot. In at least one embodiment of the present invention, improved accuracy of data presented on-lot at the vehicles being offered for sale is provided. In at least one embodiment of the present invention, a robust set of collateral information is presented on-lot at the vehicle to which the collateral information relates. In at least one embodiment of the present invention, the collateral information can be updated in real time, allowing a posted asking price to better track an accurate price the dealership is willing to take.

Although the preferred embodiments of the invention have been illustrated and described in detail, it will be readily apparent to those skilled in the art that various modifications may be made therein without departing from the spirit of the invention or from the scope of the appended claims. Such modifications and adaptations which are obvious to those skilled in the art are to be included within the scope of the present invention.

What is claimed is:

1. A method of marketing vehicles residing on a dealership lot, said method comprising:
operating a first computer having a display and a radio frequency (RF) network interface, said first computer being located at one of said vehicles, and said display being viewable from outside said one vehicle;
controlling a second computer, said second computer being in real time data communication with said first computer through said RF network interface;
forming, using said second computer, promotion presentation data configured to foster a sale of said one vehicle;
routing said promotion presentation data through said RF network interface to said first computer;
displaying, at said display of said first computer, said promotion presentation data.

2. A method as claimed in claim 1 wherein said promotion presentation data includes an asking price for said one vehicle.

3. A method as claimed in claim 2 additionally comprising:
revising, after said forming activity, said price for said one vehicle; and
updating said vehicle price portion of said promotion presentation data at said first computer in response to said revising activity.

4. A method as claimed in claim 3 wherein said revising activity is performed automatically.

5. A method as claimed in claim 1 wherein said second computer is located at a common location on said dealership lot.

6. A method as claimed in claim 1 wherein said promotion presentation data includes style data and data which are descriptive of said vehicle.

7. A method as claimed in claim 1 wherein said promotion presentation data includes a photograph of said vehicle.

8. A method as claimed in claim 1 additionally comprising routing updated portions of said promotion presentation data through said RF network interface to said first computer while said one vehicle is being marketed on said dealership lot.

9. A method as claimed in claim 1 wherein said displaying activity displays said promotion presentation data while said vehicle is turned off.

10. A method as claimed in claim 1 wherein said displaying activity displays said promotion presentation data without an electrical connection to said vehicle.

11. A method as claimed in claim 1 wherein said first computer is an electronic window sticker, and said operating activity locates a plurality of electronic window stickers at a plurality of said vehicles residing on said dealership lot.

12. A method as claimed in claim 11 wherein:
at least a portion of said promotion presentation data is updated for each of said plurality of vehicles to form updated promotion presentation data; and
said method additionally substantially concurrently routes said updated promotion presentation data to said plurality of vehicles.

13. A method as claimed in claim 1 wherein said one vehicle has a vehicle identification number (VIN), said first computer has a unique network address, and said method additionally comprises:
obtaining said VIN;
obtaining said unique network address; and
associating said VIN with said unique network address, and said promotional presentation data in a central database.

14. A method as claimed in claim 13 wherein:
said obtaining said VIN activity electronically copies said VIN from said vehicle to said central database; and
said obtaining said unique network address activity electronically copies said unique network address from said first computer to said central database.

15. A method as claimed in claim 1 additionally comprising:
configuring an Internet website to promote said vehicle; and
synchronizing at least a portion of said promotion presentation data between said website and said first computer.

16. A method as claimed in claim 1 wherein:
said promotion presentation data is partitioned into a plurality of display screens; and
said displaying activity displays a menu structure for navigating through said plurality of display screens.

17. A method as claimed in claim 1 wherein said first computer additionally has a user input device, and said method additionally comprises:
collecting, at said first computer, user response data from said user input device of said first computer; and
routing said user response data through said RF network interface.

18. A method as claimed in claim 17 additionally comprising responding to said user response data in real time to foster a sale of said one vehicle.

19. A method as claimed in claim 17 wherein said user response data collected in said collecting activity includes an interest-in-vehicle indicator.

20. A method as claimed in claim 19 additionally comprising announcing receipt of said interest-in-vehicle indicator at a location within said dealership lot remote from said one vehicle.

21. A method as claimed in claim 20 wherein:
said interest-in-vehicle indicator is annunciated at said second computer; and
said interest-in-vehicle indicator is annunciated in connection with a map of said dealership lot to indicate a location of said one vehicle on said dealership lot while indicating receipt of said interest-in-vehicle indicator.

22. A method as claimed in claim 17 wherein:
said user response data collected in said collecting activity includes a print request associated with a portion of said promotion presentation data; and
said method additionally comprises causing a printer located at a common location on said dealership lot to make a paper copy of said portion of said promotion presentation data.

23. A system for marketing vehicles residing on a dealership lot, said system comprising:
a first computer having a display, an input device, and a radio frequency (RF) network interface, said first computer being located at one of said vehicles, and said display being viewable from outside said one vehicle; and
a second computer, said second computer being in real time data communication with said first computer through said RF network interface, said second computer being configured to form promotion presentation data configured to foster a sale of said one vehicle;
wherein, said promotion presentation data is routed through said RF network interface to said first computer, said promotion presentation data is partitioned into a plurality of display screens and displayed at said display of said first computer, user response data is collected from said user input device of said first computer, and said user response data is routed through said RF network interface.

24. A system as claimed in claim 23 wherein said promotion presentation data includes a price for said one vehicle.

25. A system as claimed in claim 23 wherein said second computer is located at a common location on said dealership lot.

26. A system as claimed in claim 23 wherein said promotion presentation data includes style data and data which are descriptive of said vehicle.

27. A system as claimed in claim 23 wherein said promotion presentation data includes a photograph of said vehicle.

28. A system as claimed in claim 23 wherein:
said user response data includes an interest-in-vehicle indicator; and
said second computer is configured to receive said interest-in-vehicle indicator and to annunciate said interest-in-vehicle indicator at said second computer in connection with a map of said dealership lot to indicate a location of said one vehicle on said dealership lot while indicating receipt of said interest-in-vehicle indicator.

29. A system as claimed in claim 23 wherein said first computer is configured to display said plurality of screens of promotion presentation data and to collect said user response without making an electrical connection to said vehicle.

30. A system as claimed in claim 23 wherein:
said one vehicle has a vehicle identification number (VIN);
said first computer has a unique network address; and
said system additionally comprises a central database in which an association is recorded between said VIN and said unique network address.

31. A system as claimed in claim 30 wherein said first computer is configured to cause said unique network address to be electronically copied to said central database.

32. A system as claimed in claim 30 additionally comprising:
a processing component associated with said central database, said processing component being configured to synchronize at least a portion of said promotion presentation data displayed at said first computer and data presented at an Internet website.

33. A method of marketing vehicles residing on a dealership lot, said method comprising:
operating a plurality of electronic window sticker (EWS) computers, wherein each EWS computer has a display, an input device, and a radio frequency (RF) network interface, and each EWS computer is located at a corresponding one of said vehicles so that said display of each EWS computer is viewable from outside said corresponding vehicle;
controlling a second computer, said second computer being in real time data communication with each of said EWS computers through said RF network interfaces;
forming, using said second computer, promotion presentation data configured to foster sale of said vehicles, said promotion presentation data including style data and data which are descriptive of said vehicles, wherein said data descriptive of said vehicles include vehicle price data and vehicle photographs;
routing said promotion presentation data through said RF network interfaces to said EWS computers;
displaying, at said displays of said EWS computers, said promotion presentation data partitioned into a plurality of display screens and a menu structure for navigating through said screens;
collecting, at said EWS computers, interest-in-vehicle indicators from said user input devices of said EWS computers;
routing said interest-in-vehicle indicators through said RF network interfaces; and
responding to said interest-in-vehicle indicators in real time to foster sales of said vehicles.
